(19) United States
(12) Patent Application Publication
(10) Pub. No.: US 2012/0328031 A1
(43) Pub. Date: Dec. 27, 2012

(54) Codebooks for Mobile Communications

(75) Inventors: Kari P. Pajukoski, Oulu (FI); Kari J. Hooli, Oulu (FI); Mika P. Rinne, Espoo (FI); Sassan Iraji, Espoo (FI)

(73) Assignees: Nokia Siemens Networks Oy; Nokia Corporation

(21) Appl. No.: 13/168,099

(22) Filed: Jun. 24, 2011

(51) Int. Cl. H04L 27/00

(52) U.S. Cl. 375/259

(57) ABSTRACT

Methods, computer program products, and apparatus are disclosed performing the following: receiving a codebook; receiving one or more modifiers corresponding to the codebook; determining which portion of the codebook is to be applied to information to be transmitted; applying the portion of the codebook to the information to determine coded information; using the one or more modifiers, modifying one or more metrics; determining transmit power to be used for transmission of the coded information by using a selected one of the one or more modified metrics corresponding to the portion of the codebook; and transmitting the coded information.

### TECHNICAL FIELD

This invention relates generally to radio frequency communications and, more specifically, relates to codebooks used for communications.

### BACKGROUND

This section is intended to provide a background or context to the invention disclosed below. The description herein may include concepts that could be pursued, but are not necessarily ones that have been previously conceived, implemented or described. Therefore, unless otherwise indicated herein, what is described in this section is not prior art to the description in this application and is not admitted to be prior art by inclusion in this section.

The following abbreviations that may be found in the specification and/or the drawing figures are defined as follows:
3GPP third generation partnership project
BLER block error rate
BS base station
CbID codebook identifier
CM cubic metric
DCI downlink control information
DL downlink, from base station to user equipment
DMRS demodulation reference symbol (uplink)
eNB Node B (evolved Node B), E-UTRAN base station
EPC evolved packet core
E-UTRAN evolved UTRAN (LTE)
HO handover
LTE long term evolution of UTRAN (E-UTRAN)
LTE-A LTE advanced
MIMO multiple input, multiple output
MM/MME mobility management/mobility management entity
MPR maximum power reduction
NodeB Node B, UTRAN base station
O&M operations and maintenance
PA power amplifier
PAPR peak to average power ratio
PLMN public land mobile network
PMI precoding matrix identity
RAT radio access technology
Rel standard release (e.g., Rel-10 is release 10)
RNC radio network controller (UTRAN)
RRC radio resource control
Rx receive
SINR signal to interference plus noise ratio
SRS sounding reference symbol (uplink)
TR technical report
TS technical standard
Tx transmit
UE user equipment, such as a mobile station, mobile node or mobile terminal
UL uplink, from user equipment to base station
UTRAN universal terrestrial radio access network

One modern communication system is known as evolved UTRAN (E-UTRAN, also referred to as UTRAN-LTE or as E-UTRA). One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LTE Rel-8. In general, the set of specifications given generally as 3GPP TS 36.xyz (e.g., 36.211, 36.311, 36.312, etc.) may be seen as describing the Release 8 LTE system. More recently, Release 9 and Release 10 versions of at least some of these specifications have been published including 3GPP TS 36.300, V 10.2.0 (2010-12).

FIG. 1 reproduces FIG. 4-1 of 3GPP TS 36.300 and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to an S-GW by means of a S1 interface (MME/S-GW). The S1 interface supports a many-to-many relationship between MMEs/S-GWs/UPEs and eNBs.

The eNB hosts the following functions:

functions for RRM: RRC, Radio Admission Control, Connection Mobility Control, Dynamic allocation of resources to UEs in both UL and DL (scheduling);

IP header compression and encryption of the user data stream;

selection of a MME at UE attachment;

routing of User Plane data towards the EPC (MME/S-GW);

scheduling and transmission of paging messages (originated from the MME);

scheduling and transmission of broadcast information (originated from the MME or O&M); and

a measurement and measurement reporting configuration for mobility and scheduling.

Of particular interest herein are the further releases of 3GPP LTE (e.g., LTE Rel-10, LTE Rel-11) targeted towards future IMT-A systems, referred to herein for convenience simply as LTE-Advanced (LTE-A). LTE-A is specified in Rel-10 (see, e.g., 3GPP TS 36.300 v10.3.0 (2011-03)), further enhancements in Rel-11. Reference in this regard may also be made to 3GPP TR 36.913 V9.0.0 (2009-12) Technical Report 3rd Generation Partnership Project; Technical Specification Group Radio Access Network; Requirements for further advancements for Evolved Universal Terrestrial Radio Access (E-UTRA) (LTE-Advanced) (Release 9). Reference can also be made to 3GPP TR 36.912 V9.3.0 (2010-06) Technical Report 3rd Generation Partnership Project; Technical Specification Group Radio Access Network; Feasibility study for Further Advancements for E-UTRA (LTE-Advanced) (Release 9).

In these types of systems and other systems, many mobile devices currently use multiple-antenna transmissions. That is, information is transmitted using multiple antennas. Multiple-antenna transmissions are defined in, e.g., LTE/LTE-A using precoding matrices in standardized codebooks. In other words, there are predefined precoding matrices that are applied to information to be transmitted using multiple antennas. Multiple-antenna transmissions greatly enhance system performance, e.g., by increasing data rates, extending bit rate-coverage, and reducing mutual interference.

### SUMMARY

The embodiments set forth herein are merely meant to be exemplary.

In an exemplary embodiment, an apparatus includes one or more processors and one or more memories including computer program code. The one or more memories and the computer program code are configured to, with the one or more processors, cause the apparatus to perform at least the following: receiving a codebook; receiving one or more modifiers corresponding to the codebook; determining which portion of the codebook is to be applied to information to be transmitted; applying the portion of the codebook to the information to determine coded information; using the one or more modifiers, modifying one or more metrics; determining transmit power to be used for transmission of the coded information by using a selected one of the one or more modified metrics corresponding to the portion of the codebook; and transmitting the coded information.

In another exemplary embodiment, an apparatus includes one or more processors, and one or more memories including computer program code. The one or more memories and the computer program code are configured to, with the one or more processors, cause the apparatus to perform at least the following: determining a codebook to be used by a user equipment to be applied to information to be transmitted by the user equipment; determining one or more modifiers corresponding to the codebook, the one or more modifiers to be used by the user equipment to modify metrics used by the user equipment to determine transmit power used for transmissions by the user equipment; transmitting the codebook to the user equipment; and transmitting the one or more modifiers corresponding to the codebook to the user equipment.

### BRIEF DESCRIPTION OF THE DRAWINGS

In the attached Drawing Figures:

FIG. 1 reproduces FIG. 4-1 of 3GPP TS 36.300, and shows the overall architecture of the EUTRAN system.

FIG. 2 shows a simplified block diagram of various electronic devices that are suitable for use in practicing the exemplary embodiments of this invention.

FIG. 3 is a signaling and method diagram illustrating an exemplary RRC procedure to communicate a codebook and additional information to the UE.

FIG. 4 is a signaling and method diagram illustrating an exemplary handover procedure including a codebook identifier.

### DETAILED DESCRIPTION OF THE DRAWINGS

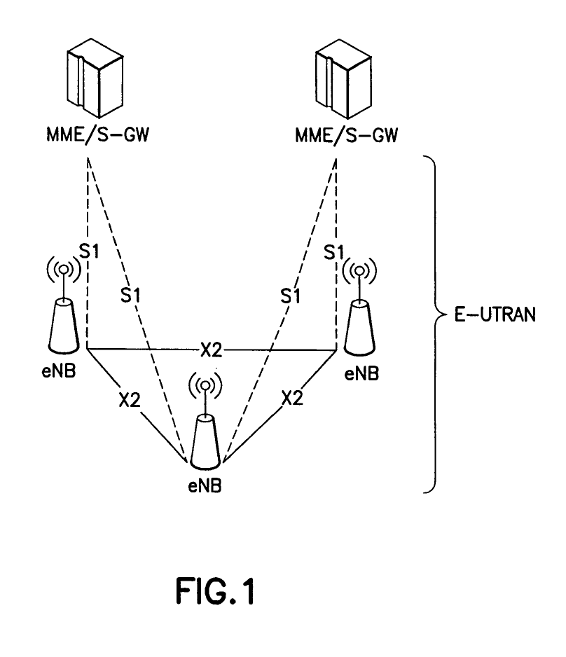

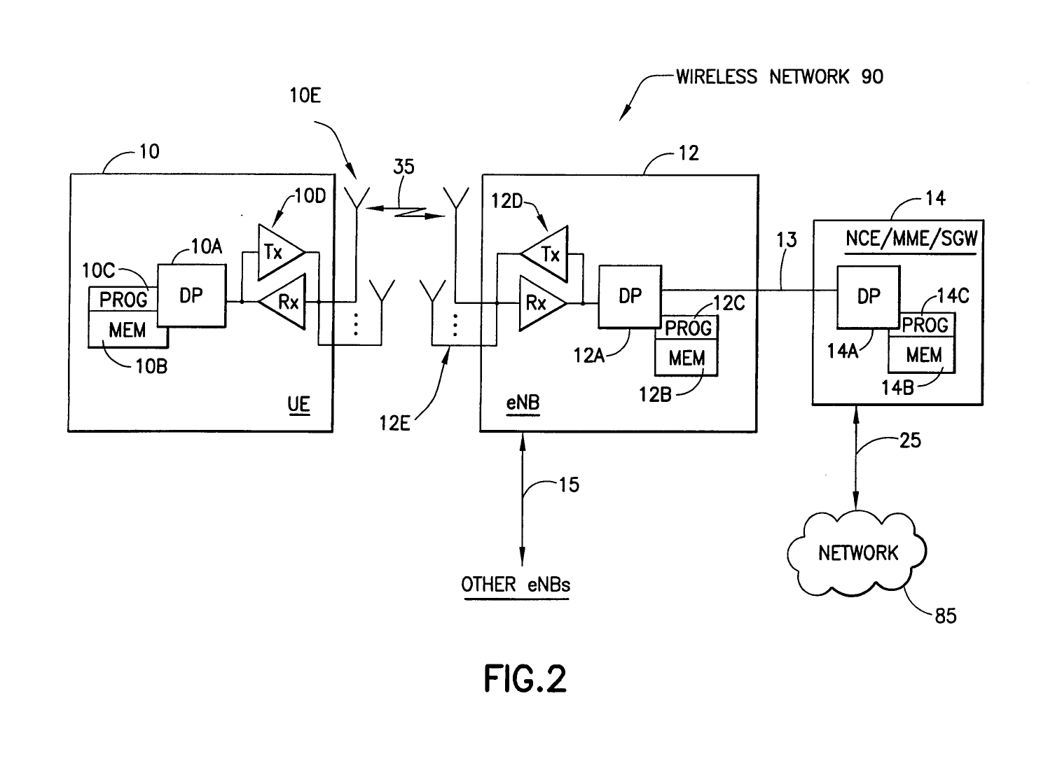

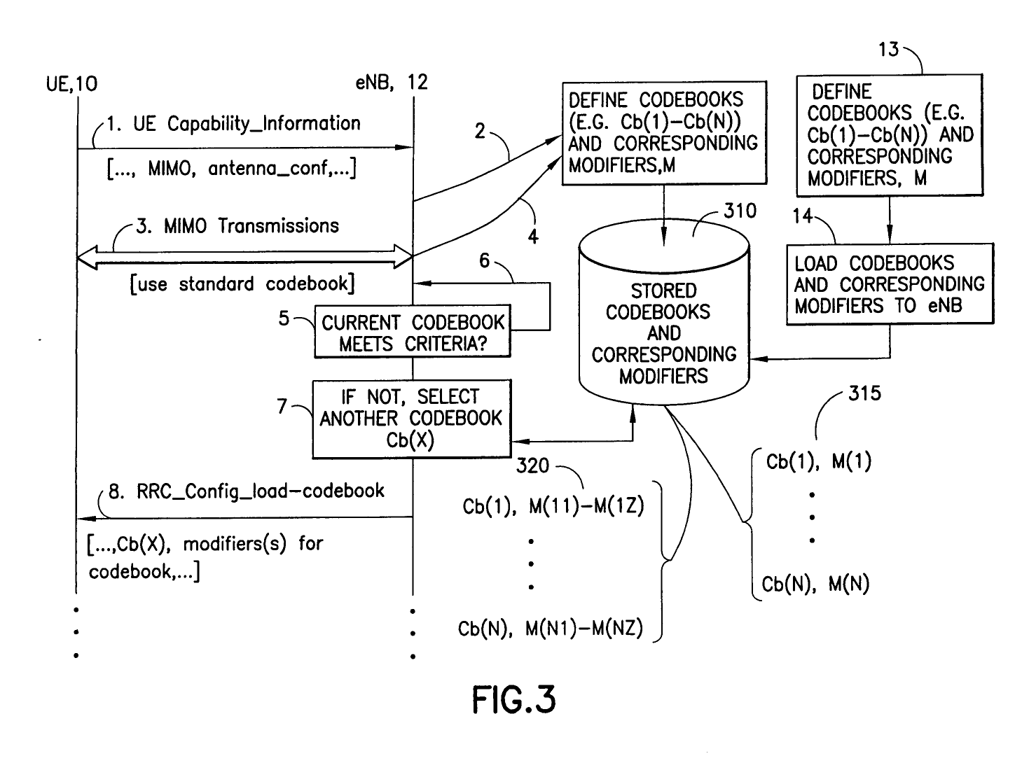

Before describing in further detail the exemplary embodiments of this invention reference is made to FIG. 2 for illustrating a simplified block diagram of various electronic devices and apparatus that are suitable for use in practicing the exemplary embodiments of this invention. In FIG. 2, a wireless network 90 is adapted for communication over a wireless link 35 with an apparatus, such as a mobile communication device which may be referred to as a UE 10, via a network access node, such as a Node B (base station), and more specifically an eNB 12. The network 90 may include a network control element (NCE) 14 that may include the MME/SGW functionality shown in FIG. 1, and which provides connectivity with a further network 85, such as a telephone network and/or a data communications network (e.g., the interne), via a link 25.

The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter and receiver pair (transceiver) 10D for bidirectional wireless communications with the eNB 12 via one or more antennas 12E. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas 12E (typically several when multiple input/multiple output (MIMO) operation is in use). The eNB 12 is coupled via a data/control path 13 to the NCE 14. The path 13 may be implemented as the S1 interface shown in FIG. 1. The eNB 12 may also be coupled to other eNBs via data/control path 15, which may be implemented as the X2 interface shown in FIG. 1. The NCE 14 also includes a controller, such as at least one computer or a data processor (DP) 14A, and at least one computer-readable memory medium embodied as a memory (MEM) 14B that stores a program of computer instructions (PROG) 14C.

At least one of the programs 10C and 12C are assumed to include program instructions that, when executed by the associated DP 10A, 12A, enables the corresponding UE 10, eNB 12 to operate in accordance with the exemplary embodiments of this invention, as will be discussed below in greater detail. The exemplary embodiments of this invention may be implemented at least in part by computer software executable by at least one of the data processors, or by hardware (e.g., an integrated circuit defined to carry out one or more of the operations described herein), or by a combination of software and hardware.

In general, the various embodiments of the UE 10 can include, but are not limited to, cellular phones, personal digital assistants (PDAs) having wireless communication capabilities, tablets having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B and 12B may be of any type suitable to the local technical environment and may be implemented using any suitable data storage device and corresponding technology, such as semiconductor based memory devices, random access memory, read only memory, programmable read only memory, flash memory, firmware, microcode, magnetic memory devices and systems, optical memory devices and systems, fixed memory, and removable memory. The data processors 10A and 12A may be of any type suitable to the local technical environment, and may include one or more of general purpose computers, special purpose computers, microprocessors, digital signal processors (DSPs) and processors based on multi-core processor architectures, as non-limiting examples.

In MIMO for LTE, closed loop precoding from a defined codebook is used for transmission in order to form the transmitted layers. In broad terms, a codebook consists of a set of predefined precoding matrices, with the size of the set being a trade-off between the number of signaling bits required to indicate particular matrix in the codebook and the suitability of the resulting transmitted beam direction. For additional detail, see S. Sesia, I. Toufik, and M. Baker, “L—The UMTS Long Term Evolution”, e.g., Chapter 11 (“Multiple Antenna Techniques”) (2009).

The predefined codebooks, which have been standardized in 3GPP standard specifications, must be implemented by the UE. Whenever there is need to define a new codebook, the 3GPP approach has been to standardize the new codebook, and require signaling support, whether a given codebook is implemented by the UE or not. These indications are multi-antenna and feedback signaling capability indicators, or feature group indications (FGIs). The approach for standardizing alternative codebooks is not a sufficiently flexible method. It is expected that the number of various antenna arrangements will significantly increase in the future. The eNB antenna array (e.g., 12E of FIG. 2) may be located and coordinated over multiple geographical sites or be used as distributed radio front ends (e.g., remote radio heads). Also, mobile device categories will have a larger variety of antenna placements. For instance, antenna placement on a tablet may be different from antenna placement on a typical cell phone. It will be a complex problem to find a limited set of codebooks suitable to be standardized for the whole range of base station antenna arrangements and device antenna arrangements, respectively. Also, standardizing many codebook variants is not a fast process.

Another approach, which is not based on codebooks, may be to signal the long term channel coefficients for the feedback, in order to define the proper precoding matrix to use over a long time period. This however imposes a problem of large feedback overhead, and due to long delay the transmission is not capable to adapt to short term variations of the channel coefficients.

The metric cubic metric (CM) (and correspondingly also peak-to-average power ratio, PAPR) are indications of the adjacent channel leakage ratio (ACLR) and are used as indications of how much power amplifier (PA) power headroom is required to avoid entering the non-linear region of operation for the PA. See S. Sesia, I. Toufik, and M. Baker, “LTE—The UMTS Long Term Evolution”, e.g., Chapter 22.3.3 (“Power Amplifier Considerations”) (2009). Concerning this, another problem is that the precoding can affect UL transmission CM (or other corresponding metric). In other words, the CM can vary between different codebooks. However, the UE needs to know a CM value (or other corresponding metric) for a transmission for appropriate setting of the operation point in the linear region of the UE power amplifier (PA). Via the PA operation point setting, the CM value affects the UE transmit power, especially by affecting the maximum transmit power that can be used. A conventional UE signals a power headroom report (PHR) to the eNB for scheduling decisions. These reports do not include an impact of CMs of different codebooks.

In this document, techniques are proposed in exemplary embodiments that download a complete codebook at need from a network 90, e.g., from the eNB 12 to the UE 10. The codebook is defined for specific properties that are expected to provide gains compared to the use of a standard codebook. The codebook may be downloaded for the use of uplink transmission, or the codebook may be downloaded for the use of downlink transmission. The codebooks for downlink use and uplink use are very likely independent from each other. The loaded codebook may be designed for the particular antenna configurations that are used by the eNB and UE and for the particular radio propagation environment of corresponding cell. The codebook is communicated to the UE by the eNB in, e.g., radio resource control (RRC) signaling, and may be stored in the HE memory 10B. The codebook definitions may occur 1) by mathematical techniques, 2) experimentally by executing field measurements, and/or 3) by learning from the imperfections of the currently used codebook. Codebook design is described in more detail below.

Certain exemplary embodiments of the invention further include that Cubic Metric/Maximum Power Reduction (CM/MPR) modifier(s) is/are signaled with a corresponding downloaded codebook. The MPR is described in a number of documents including 3GPP TS 36.101 V9.6.0 (2010-12) sections 6.2.3 (“UE Maximum Output power for modulation/channel bandwidth”) and 6.2.4 (“UE Maximum Output Power with additional requirements”). A formula to determine MPR from CM is shown in 3GPP TS 25.101 V 10.0.1 (2011-01), section 6.2.2 (“UE maximum output, power with HS-DPCCH and E-DCH”) as MPR (in dB, decibels)=MAX (CM−1, 0), where MAX selects the maximum value between CM−1 and zero. The signaled modifiers are used to replace or modify the default (standardized) MPR values for precoded transmission as well as to provide UE information about the precoded transmission signal amplitude variation characteristics for appropriate setting of the PA operation point, which, in turn, determines transmit power. A CM modifier would be similarly determined to replace/modify values of CM used otherwise (either due to use without precoding or due to the use with precoding by a standardized codebook). The CM values or their modifiers for standardized codebooks may appear in a standard. The modifier has an actual impact in the power headroom report (PHR) of the UE to the eNB, as well as for setting the PA operation point or transmit power. The CM/MPR metric is a critical decision factor, which codebook to use for transmission, and the metric impacts the transport formats the eNB scheduler may assign to the UE at a scheduling event. Because CM/MPR metric impacts the efficiency of the UE power amplifier, the metric impacts the signal coverage, e.g., the SINR or SNR implied range of signal reception, which depends for example on the transport format, transmit power, transmitter geometry and receiver capabilities.

In more detail, CM is a design factor, which impacts the UE power amplifier, its power consumption and physical size, hence also to the form factor of the device. Momentarily, at a time of transmission, the power resources of UE 10 may be limited, and based on the power headroom report (PHR), the eNB can only allocate certain transport formats to the UE, which meet a target BLER value with the transmit power resources available at the UE. The transmit power depends on the allocated bandwidth (corresponding to physical resource blocks), modulation and coding. Further, the transmit power depends on the multi-antenna configuration, properties of the antennae and the selected multi-antenna transmission format. Additionally, according to exemplary embodiments of the instant invention, the transmit power further depends on the selected codebook and on the precoding matrix from the selected codebook to be selected for the transmission. In case the new codebook so implies that there is an MPR multiplier of the precoding matrix, the UE power amplifier (as determined by the UE) has to tune its operation point in the linear region of the power amplifier output power. Therefore, based on MPR information and based on UE reports, the eNB may have to take into account in its momentarily decision of transport format and precoding matrix that their combination forms the best expected throughput in those momentary (e.g., spatially structured) channel conditions. In some cases, the eNB selection becomes limited by the properties of the UE antenna array (e.g., 10E), by the power amplifier, and by the power resources available, and the eNB is not able to select the transport format the eNB would like to select. In this case, the eNB has to select another format, for example lower the rank of a precoder or schedule the UE to more favorable transmission time or frequency resource blocks.

The approach for CM/MPR metrics of the codebook in this document is that the CM/MPR metrics may differ for different codebooks and the CM/MPR metrics may also differ per rank for a single codebook. The CM/MPR metric is defined, in an exemplary embodiment, for each modulation order separately. However, it may not be a good design to define codebooks where the signaled CM/MPR metric differs between the precoding matrices of the same rank of a single codebook. Nonetheless, this is not excluded.

The aspects of the exemplary embodiments of the instant invention may also include, in addition to the CM/MPR metrics, the following:
RRC signaling of the codebook;
Definitions of the signaling elements of a codebook;
Handover, including codebook signaling elements;
Specifics of codebook use for uplink/downlink transmissions; and
UE capability signaling.

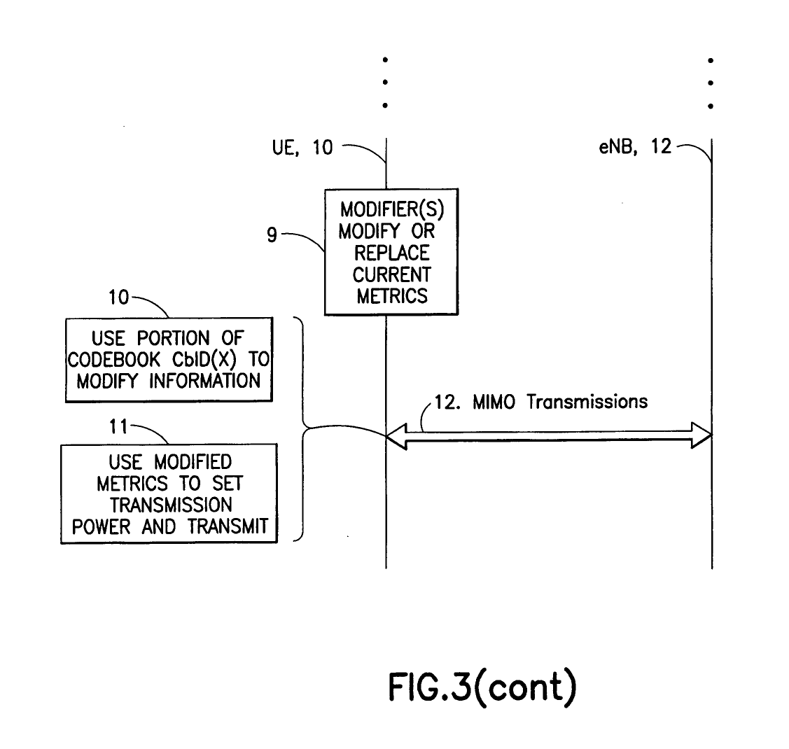

Concerning RRC signaling for codebooks, an exemplary implementation of the RRC signaling for loading a codebook from the network (eNB) to the UE is shown in FIG. 3. In operation 1, the UE 10 sends capability information ([ . . . , MIMO, antenna_conf, . . . ]) to the eNB 12. In UE_capability_information, the UE 10 typically signals that the UE has a capability to operate in multi-antenna transmission modes, and the UE describes the structure and properties of its antennae. It is up to the eNB to decide when to use multi-antenna transmission modes and how to use them. These decisions will largely be based on the UE-provided feedback and measurements. The multi-antenna capability in the UE allows the UE to perceive the rank and the spatial structure of the channel. Some of this information may be frequency selective that differs for the frequency components over the full transmission band. If carrier aggregation of multiple component carriers is used for transmission, the transport formats per component carrier may differ a lot, or the transport formats may even be nearly independent of each other, because the component carriers may face mutually differing spatial propagation and correlation properties of the channel.

The “antenna_conf” is described in more detail below. Briefly, however, as stated above, the downloaded codebook may be designed for the particular antenna configurations that are used by the eNB and UE and for the particular radio propagation environment of the corresponding cell. In operation 2, the “antenna_conf” information is used to define one or more codebooks. The antenna configuration (as indicated by the “antenna_conf”) may concretely impact the actual codebook design or its tuning. Codebooks could mitigate some of the antenna imperfections, or certain codebooks could be designed with particular optimizations to the antenna configurations. For example, there can be a codebook for uniform linear array (ULA), and another set of codebooks for differently polarized antennas. Additionally, the antenna configuration may impact, at a time of transport format selection, so that the rank and the preceding matrix are selected that are expected to yield best transmission properties for the momentary channel conditions. For instance, a UE with a ULA configuration could typically have less throughput compared to properly polarized antenna patterns in a channel that has directive polarization properties. Additionally in operation 2, corresponding modifiers (e.g., CM, MPR) are determined and stored in stored codebooks memory 310 (e.g., in memories 12B). These values are used by UE 10 to modify the power amplifier operating point for a power amplifier of the UE 10.

Normally, any of the closed-loop precoded multiple antenna transmissions use a standardized codebook of precoding matrices for each transmission. This occurs in operation 3. In operation 4, based on, e.g., the MIMO transmissions in operation 3, the eNB 12 may define or refine the one or more codebooks or the corresponding value(s) in the stored codebooks memory 310. According to an exemplary embodiment of the instant invention, the standard codebook is replaced by a downloaded codebook Cb(x), identified by codebook identifier (CbID(x)). Switching to use a new codebook Cb(x) is decided by the eNB in an exemplary embodiment, e.g., in response to detecting that the performance of the standard codebook is not sufficiently high enough compared to predetermined criteria (operation 5). The performance of the codebook can be measured by, e.g., estimating the throughput gains the codebook provides, by transmit power saving the codebook may obtain, by received SINR and BLER measurements, and by spectral efficiency of transmission. These measures may be benchmarked to the theoretical expected values like a Shannon formula in given channel conditions, or the benchmark may compare the expected relative numbers with precoding versus without precoding, or the measures can be compared to a statistical history. For example, if the gains relative to the channel start deteriorating for a given codebook, tuning of the precoding matrices in the codebook may be used to search for a better, more optimal, set of precoders, which once used become visible in the improved transport metrics again. If the current codebook meets the predetermined criteria, operation 6 is performed and MIMO operations from block 3 are continued.

As indicated by reference 315, each of the N codebooks Cb(1) to Cb(N) could have a single modifier M(1) to M(N), respectively, corresponding to the codebook. As another example, as indicated by reference 320, each of the N codebooks could have multiple modifiers M(11) to M(NZ) corresponding to the codebook. For instance, each of the modifiers M(xy) could correspond to modulation order and/or rank. Typical modulation orders might be three, e.g., QPSK (quadrature phase shift keying), 16-QAM (quadrature amplitude modulation), and 64-QAM, but other modulation orders may be used.

If the current codebook does meet the predetermined criteria, in operation 7, the eNB 12 selects a defined codebook Cb(x) from the stored codebooks memory 310 and communicates the codebook and modifiers(s) M to the UE 10 in operation 8. In operation 9, the UE 10 modifies or replaces current metrics (e.g., CM/MPR) with the downloaded modifiers. In typical MIMO operation, a portion (such as a precoding matrix) of the new codebook Cb(x) is selected (operation 10) and the modified metrics are then used (in block 11) to set the power amplifier operating point. MIMO transmissions occur in operation 12 using the new codebook Cb(x) and the modified metrics. For the MIMO transmission in operation 12, operations 10 and 11 would be performed for each transmission. However, operation 10 is not needed in some cases of retransmissions, as the precoder is not changing. Operation 11—setting transmission power—is affected by several issues, e.g., changing number of PRBs, or changing path loss estimate. So this operation would typically be performed for each transmission. It is noted that downloading a new codebook in operation 8 and the use of the codebook in subsequent operations (e.g., operation 10) need not occur “near” each other in time. For instance, operation 8 could occur well before the downloaded codebook is used in subsequent operations.

As described below, codebooks apply separately for downlink (eNB) transmissions and for uplink (UE) transmissions. These codebooks need not be the same and need not have similar properties. The use of codebooks for downlink and uplink are independent. The UE transmits feedback for the eNB transmissions in downlink. For uplink, the eNB measures UE transmissions and gives feedback or instructions for the UE transmissions. The receiver needs to verify the transmitted precoding matrix, either by searching for the maximum likelihood of precoders or from the error protected signaling elements. The transmission in operation 8 from the eNB 12 to the UE 10 is feasible because signaling of an entire codebook takes around 1 (one) kB (kilobyte). For example, if considering 4 (four) Tx antennas, 3 (three) bits for phase and 1 (one) bit for amplitude results in 4*(3+1)=16 bits per precoder per transmission layer. Considering the total of 53 precoding matrices of current LTE-Advanced system, containing 24 rank-1 precoding vectors with one transmission layer, 16 rank-2 precoding matrices with two transmission layers, 12 rank-3 precoding matrices with three transmission layers, and one rank-4 precoding matrix with four transmission layers, produces (24+16*2+12*3+1*4)*16=1536 bits (−200 Bytes) of protocol payload.

The information defining a codebook Cb(x) can include the following: a codebook identifier (CbID(x)); a maximum transmission rank, i.e., maximum number of spatial layers (Nᵥ) number of precoding matrices for each transmission rank (e.g., as a list of numbers); codebook index(es) (e.g., as a list of indexes); and/or a precoding matrix (e.g., as a list of matrices).

The codebook identifier CbID(x) separates the downloaded codebook from the codebook given in the standard specification and from other possibly downloaded codebooks. The maximum transmission rank defines the maximum number of spatial layers used in transmission. The number of precoding matrices for each transmission rank defines how many precoding matrices the codebook contains for each rank. The codebook index is typically a list of indexes for the precoding matrices in the codebook. The precoding matrix is typically a list of precoding matrices in the codebook, where each precoding matrix is a complex matrix including a real multiplier for normalization, and a set of complex numbers defining an amplitude weight factor for each transmit antenna and spatial layer pair and a relative phase shift between the antennas for corresponding layer.

As additional information, the codebook may include a pre-calculated value for the CM (or MPR) of each rank. The computation of CM (or MPR) can be performed off-line on behalf of the UE. In an exemplary embodiment, the CM/MPR metrics are provided per rank for the codebook, because exemplary embodiments of the instant invention relax the design of the codebook for precoding matrices by having CM/MPR as a parameter, contrary to the cubic metric preserving (constant) designs. Relaxing this design parameter allows more freedom to the codebook design, which may enable much better codebooks in other terms. Another additional information element of the codebook is in an exemplary embodiment the MPR modifier that will act as a modifier to the MPR values used at the UE transmitter for the UL transmissions with corresponding rank. This modifier reflects the precoding impact on the peak-to-average power ratio, or the precoding impact on amplitude variation characteristics of the modulated data and may assist the UE in selecting an appropriate PA power setting especially when operating close to the maximum output power. The MPR modifier can indicate the amount that default/standardized MPR values are changed for the precoded transmission of corresponding rank. The MPR modifier is in an exemplary embodiment specific for each modulation order. That is, there are multiple MPR modifiers, one for each modulation order and, e.g., for corresponding rank. Alternatively, codebook signaling may contain also a whole set of MPR values replacing the default MPR values for precoded transmissions.

In addition to the eNB defining the codebooks, operations 13 and 14 illustrate that the codebooks and corresponding modifiers may be defined offline (operation 13), e.g., by the network. The network or eNB 12 would then load (operation 14) the codebooks and corresponding modifiers into the eNB 12 and the codebooks and corresponding modifiers would be stored in stored codebooks memory 310.

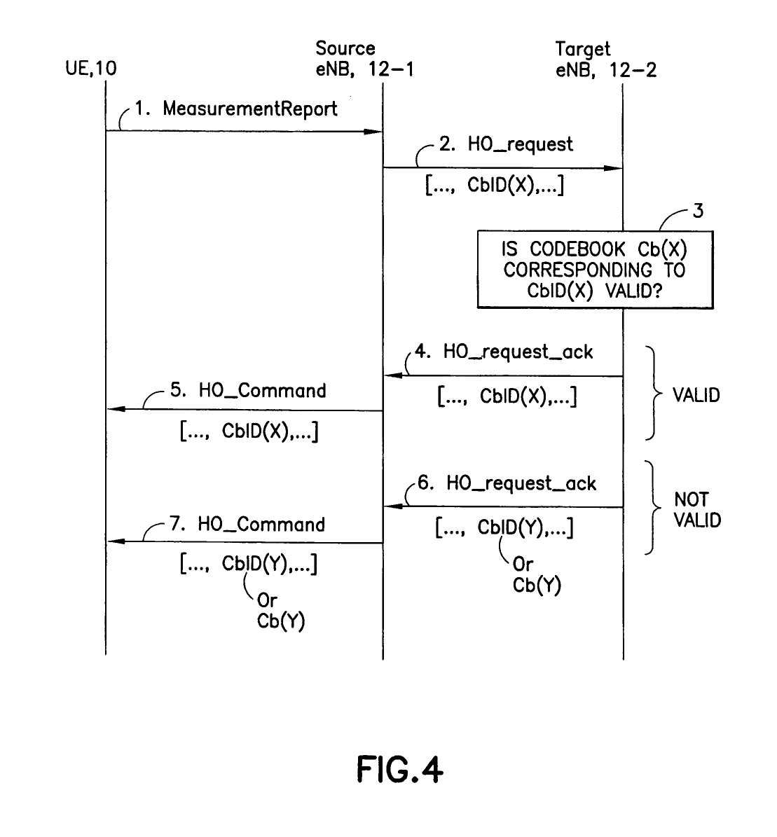

Regarding handover, FIG. 4 is a signaling and method diagram illustrating an exemplary handover procedure including a codebook identifier. If a codebook is not known by the UE, the codebook has to be fully downloaded to the UE with all the information elements of the codebook and its additional modifiers like CM and MPR. Codebook identity is proposed herein so that there may be multiple codebooks as alternatives, and their use is uniquely understood between the UE and the eNB. Further, it is proposed in an exemplary embodiment that a codebook identity is unique in a given PLMN of an operator so that the eNB network may understand a reference uniquely. This means that at the handover, a source eNB may refer to the target eNB shortly by the codebook identity, and the target eNB has a unique understanding of its precoding matrices and CM/MPR metrics. Originally, the set of codebooks can be loaded to the eNB network from the O&M, or network planning tool, of the network operator. If an eNB 12 modifies the contents of a codebook by tuning its precoding matrices for its local operations, presumably the reference by a codebook identity CbID to a target eNB can only make a reference to the original contents of that codebook.

Typically the propagation environment is specific to a footprint of a cell, and one can assume that a codebook is loaded by the serving (source) eNB 12 to the UE 10. However, it is also possible that a given codebook is valid for a larger area including several eNBs. In this situation, one faces the issue of handover signaling of the loaded codebook. As a fallback solution, the eNB 12-2 and UE may start with a standardized codebook always after handover, and switch to a loaded codebook only after the load is completed in the new serving (e.g., target) eNB 12-2 after the handover. Another approach is that at the handover (see FIG. 4), the source eNB indicates to the target eNB the codebook identity (CbID(x)) of the UE (HANDOVER_REQUEST message) (operation 2), and if the target eNB supports this codebook also (as determined in operation 3), the target eNB 12-2 acknowledges that the same codebook will be used for that UE after the handover (HANDOVER_REQUEST_ACKNOWLEDGE message) (operation 4). Then, the handover command (operation 5) from the source eNB 12-1 to the UE will include an Information Element of the codebook identity in use in the target cell. The signaling of the codebook identity in the handover command is not present in current systems. Also the query and response about the codebook validity between the source eNB and the target eNB over the X2-interface (X2AP) is new.

Operations 4 and 5 are performed in an exemplary embodiment in response to the codebook Cb(x), corresponding to the CbID(x), being valid in operation 3. If the codebook Cb(x), corresponding to the CbID(x), is not valid in operation 3, then operations 6 and 7 are performed. In an example, in operation 6, the HO_request_ack message has an identification (CbID(y)) of a different codebook (Cb(y)). The HO_Command message in operation 7 passes this identification to the UE 10. Sometime after handover, the eNB 12-2 transfers the codebook Cb(y) to the UE 10. Alternatively, the codebook Cb(y) could be transferred (as indicated in FIG. 4) in operations 6 and 7.

It is noted in this example that the codebooks include the modifier(s), M. That is, in operations 6 and 7, if the codebook Cb(y) is communicated from the eNB 12-2 to the UE 10, the codebook Cb(y) includes corresponding modifier(s), M. However, the modifier(s) may be sent separately, if desired.

An example is now presented of usage of a codebook for uplink transmission. The total number of precoding matrixes over all transmission ranks can be aligned with the PMI signaling capability existing in PDCCH DCI format used in UL MIMO transmission mode. For example, DCI format 4 (four) is used in Rel-10 with PUSCH transmission mode 2 (two), and the eNB can signal 64 precoders for transmission of 1 (one) transport block (TB) and another 64 precoders for transmission of 2 (two) transport blocks (TBs) in the case of 4 (four) Tx antennas at the UE. In the case that UE has 2 (two) Tx antennas, the eNB can signal 8 (eight) precoders for transmission of 1 (one) TB and another 8 (eight) precoders for transmission of 2 (two) TBs.

As a consequence, once selecting the codebook to use and having the defined precoding matrices, the UE 10 will receive rank indication and precoding matrix indication (PMI) according to standardized techniques without any need to change, e.g., precoding information field size in corresponding DCI format(s).

Although such codebook alignment is preferable, it is not necessary. In another exemplary embodiment, codebook signaling elements need to contain also precoding information field size in corresponding DCI format.

Regarding UE capability signaling (operation 1 of FIG. 3), in a conventional system, the UE will signal a UE_Capability_Information message to the network. In this document, it is proposed that if the UE has multiple antennas this Capability Information message includes an additional indicator, whether UE supports downloaded (e.g., non-standardized) codebooks. An example of this message is as follows:

```
UE_Capability_Information {
    ...
Downloaded codebooks allowed: yes / no
    Highest rank of downloaded codebook: 4
}
```

Another new information element which supports codebook adaptation in the UE_Capability_Information is called the antenna arrangement indicator (shown as “antenna_conf” in FIG. 3). This indicator can be based on a predefined set of antenna arrangements, e.g., whether the UE has a uniform linear array (ULA), whether the UE has polarized antenna elements (horizontal, vertical, cross-polarized), or whether the UE has ULA of cross-polarized antenna pairs, or whether the arrangement of antenna elements is unknown and may the arrangement include large differences in the quality of antenna chains. An example:

```
UE_antenna_array_indicator;{
    UE_Antenna_type: ULA / polarized (vertical, horizontal, cross)
    / ULA of cross-polarized antenna pairs/ undefined
}
```

The use of a downloadable codebook for downlink transmission is now described. Previously, use of a downloadable codebook for uplink MIMO was discussed. It should be noted that also downlink MIMO will face similar concerns in codebook design, when the range of antenna arrangements and propagation conditions is extended. A downloadable codebook can be used to optimize the transmissions to the surrounding propagation environment and to the specific eNB antenna arrangement. The UE would need to know the codebook, for the proper feedback of precoding matrix selection and channel state information. In addition, for downlink transmissions, there is a special issue of channel state reference signals, which may also use precoding, and therefore their codebook needs to be known by the UE also.

The use of UE-specific reference signals may effectively hide the precoder from the UE. However, the codebook (or the UE-specific reference signals) is used in the UE in definition of the channel state information (CSI) and precoding matrix indication (PMI) feedback sent to the eNB.

Once selecting the codebook to use and having the defined precoding matrices, the UE will feed back rank indication and precoding matrix indication (PMI) according to standardized techniques. The number of feedback bits for the PMI will naturally depend on the number of spatial layers and the number of precoding matrices in the codebook. Alternatively, the number of PMI feedback bits can be fixed to correspond to the standardized codebook design. Once the codebook is loaded to the UE and its usage is set and verified by both the eNB and the UE, there is no ambiguity of the related signaling in the use of the codebook. The forward signaling and feedback signaling are exact, as in the conventional system using a standardized codebook. A difference is that a precoding matrix index does not refer to the standard codebook but to the downloaded codebook (CbID(x)).

The precoding matrices may be defined for the following purposes without loss of generality: transmit diversity, cyclic delay diversity, spatial multiplexing and beamforming.

Codebook design is now described in some examples. The codebook can be designed 1) by mathematical techniques, 2) experimentally by executing field measurements, and 3) by learning from the imperfections of the currently used codebook.

The mathematical techniques can take whatever complexity is required for mapping the precoding matrices to the expected space of complex numbers. The precoding matrices may be spread uniformly or non-uniformly to the complex space. The outcome of such a mathematical design is a parameterized codebook including defined precoding matrices.

The codebook design based on field measurements targets characterizing a propagation environment, e.g., experienced under a footprint of transmitting cell, and matches a set of precoding matrices to the measured data. Such a characterization may include propagation conditions with spatial information, e.g., experiences of angular spread, azimuth spread, path losses etc. These experiences typically depend on the antenna height, number of transmit and receive antennas, geographical location of receive antennas, antenna correlation, path correlation, placement and type of scatterers, shadowing, polarization, etc. This method is suitable for all cell sizes from macro, micro, pico to femto and for all deployments. However, certain deployments and certain propagation environments may especially experience a gain. These include directive transmissions in city centers, traffic hotspots which tend to move according to the time of the day and places which hit “bad urban” propagation, as well as heterogeneous network deployments. However, especially attractive is to use specific codebooks for indoor small cell deployments, which may have a specific spatial structure. Characterization may reflect operational configurations of the eNB, such as measures describing expected or desired SINR distribution in the cell. As an example, when SINR distribution (or number of Rx antennas at the eNB) does not support frequent use of high rank transmissions (e.g., rank 3 and rank 4), the codebook may be defined to use more precoding matrices for low rank transmissions (e.g., rank 1 and rank 2). Alternatively, in small indoor cell deployments serving hotspots, SINR distribution can allow for frequent use of high rank transmissions. Then the codebook can be defined to use more precoding matrices for high ranks and fewer for rank 1.

The codebook design based on precoding feedback history collects statistics about the use of precoding matrices, and analyses their imperfections, utilizing, e.g., channel information extracted from Sounding Reference Symbol (SRS) measurements. A new codebook can be designed from the original codebook to alleviate the observed imperfections. As an example, if use of certain precoding matrices, e.g., in MU-MIMO, does not result in suitable interference isolation between users, a precoding matrix adaptation may be used to change the actual precoding matrices. The new codebook could then include new precoding matrices with different set of rotations between transmit antennas.

Exemplary advantages of the downloaded codebook compared to the standardized codebooks include that the downloaded codebook may be more optimally mapped to the local propagation (e.g., angular spread) environment, the downloaded codebook may be created based on the knowledge of the antenna configuration, and the downloaded codebook may provide better precoding matrices to the current need, e.g., for a specific multi-user operation (MU-MIMO) or interference rejection.

The benefit of using RRC signaling for the codebook and its modifiers is that this signaling is integrity protected so that the correct downloading of the codebook can be verified, and fraudulent provision of codebooks is prevented. The network can actually load multiple codebooks to the UE, in advance, and then activate an appropriate one of the codebooks for use at a time of need. In this document, a unique codebook identifier is proposed for this purpose. Before downloading the codebooks, the eNB may request an antenna configuration indication (antenna_conf in FIG. 3) from the UE. This indication provides to the eNB information about the antenna arrangement of the UE and may facilitate the appropriate selection and definition of a suitable codebook. This signaling can be included to the UE_Capability Information, shown in operation 1 of FIG. 3 above. An exemplary advantage is that the codebook signaling includes pre-calculated CM/MPR values that impact UE transmissions, and therefore eNB scheduling decisions.

Exemplary advantage include one or more of the following non-limiting advantages:
There is no need to standardize codebooks, in addition to those already in the specification;
The eNB has the flexibility to configure codebooks for a UE, e.g., based on field measurements or knowledge of propagation, e.g., the angular spread;
This enables signaling of UE antenna arrangement, which impacts the selection of codebooks by the eNB;
This enables signaling of the CM/MPR metric of the codebooks (per rank) and allows the UE to appropriately set the operation point in the linear region of the UE power amplifier, where the impacts of CM/MPR are taken into account for the eNB scheduling; Note that this may cause an impact in the order of 1.8 dB in coverage and 3 dB in power efficiency.

In an exemplary embodiment, a method includes receiving a codebook; receiving one or more modifiers corresponding to the codebook; determining which portion of the codebook is to be applied to information to be transmitted; applying the portion of the codebook to the information to determine coded information; using the one or more modifiers, modifying one or more metrics; determining transmit power to be used for transmission of the coded information by using a selected one of the one or more modified metrics corresponding to the portion of the codebook; and transmitting the coded information.

The method of paragraph [0060], wherein the one or more modifiers is a single value corresponding to the codebook.

The method of paragraph [0060], wherein the codebook comprises a codebook identifier; a maximum transmission rank; a list of a number of precoding matrices for each transmission rank; a list of codebook indexes; and a plurality of precoding matrices.

The method of paragraph [0060], wherein the one or more modifiers comprises a plurality of modifiers, each of the modifiers corresponding to one or both of modulation order or rank in the codebook.

The method of paragraph [0060], wherein the method further comprises: prior to receiving a codebook, transmitting to a base station an indication of an antenna configuration of a plurality of antennas of the user equipment, the indication to be used by the base station to determine the codebook.

The method of paragraph [0064], wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

The method of any one of paragraphs [0060] to [0065] wherein the one or more modifiers comprise modifiers for maximum power reduction.

The method of paragraph [0066], wherein the one or more modifiers for maximum power reduction either replace current metrics for maximum power reduction or modify current metrics for maximum power reduction.

The method of any one of paragraphs [0060] to [0065], wherein the one or more modifiers comprise modifiers for cubic metrics.

The method of paragraph [0068], wherein the one or more modifiers for the cubic metrics either replace current metrics for the cubic metrics or modify current metrics for the cubic metrics.

In another exemplary embodiment, a computer program product is disclosed comprising a computer-readable medium bearing computer program code embodied therein for use with a computer, the computer program code comprising code for performing any operation in one of paragraphs [0060] to [0069]. For instance, an exemplary embodiment comprises a computer program product comprising a computer-readable medium bearing computer program code embodied therein for use with a computer, the computer program code comprising: code for receiving a codebook; code for receiving one or more modifiers corresponding to the codebook; code for determining which portion of the codebook is to be applied to information to be transmitted; code for applying the portion of the codebook to the information to determine coded information; code for, using the one or more modifiers, modifying one or more metrics; code for determining transmit power to be used for transmission of the coded information by using a selected one of the one or more modified metrics corresponding to the portion of the codebook; and code for transmitting the coded information.

In an exemplary embodiment, an apparatus includes means for receiving a codebook; means for receiving one or more modifiers corresponding to the codebook; means for determining which portion of the codebook is to be applied to information to be transmitted; means for applying the portion of the codebook to the information to determine coded information; using the one or more modifiers, modifying one or more metrics; means for determining transmit power to be used for transmission of the coded information by using a selected one of the one or more modified metrics corresponding to the portion of the codebook; and means for transmitting the coded information.

The apparatus of paragraph [0071], wherein the one or more modifiers is a single value corresponding to the codebook.

The apparatus of paragraph [0071], wherein the codebook comprises a codebook identifier; a maximum transmission rank; a list of a number of precoding matrices for each transmission rank; a list of codebook indexes; and a plurality of precoding matrices.

The apparatus of paragraph [0071], wherein the one or more modifiers comprises a plurality of modifiers, each of the modifiers corresponding to one or both of modulation order or rank in the codebook.

The apparatus of paragraph [0071], further comprising: means for, prior to receiving a codebook, transmitting to a base station an indication of an antenna configuration of a plurality of antennas of the user equipment, the indication to be used by the base station to determine the codebook.

The apparatus of paragraph [0075], wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

The apparatus of any one of paragraphs [0071] to [0076], wherein the one or more modifiers comprise modifiers for maximum power reduction.

The apparatus of paragraph [0077], wherein the one or more modifiers for maximum power reduction either replace current metrics for maximum power reduction or modify current metrics for maximum power reduction.

The apparatus of any one of paragraphs [0071] to [0076], wherein the one or more modifiers comprise modifiers for cubic metrics.

The apparatus of paragraph [0079], wherein the one or more modifiers for the cubic metrics either replace current metrics for the cubic metrics or modify current metrics for the cubic metrics.

In another exemplary embodiment, a method includes: determining a codebook to be used by a user equipment to be applied to information to be transmitted by the user equipment; determining one or more modifiers corresponding to the codebook, the one or more modifiers to be used by the user equipment to modify metrics used by the user equipment to determine transmit power used for transmissions by the user equipment; transmitting the codebook to the user equipment; and transmitting the one or more modifiers corresponding to the codebook to the user equipment.

The method of paragraph [0081], wherein the one or more modifiers is a single value corresponding to the codebook.

The method of paragraph [0081], wherein the one or more modifiers comprises a plurality of modifiers, each of the modifiers corresponding to one or both of modulation order or rank in the codebook.

The method of paragraph [0081], wherein the method further includes: prior to transmitting the codebook: receiving from the user equipment an indication of an antenna configuration of a plurality of antennas of the user equipment; and using the indication to one or both of select the codebook from a plurality of codebooks or determine the codebook.

The method of paragraph [0084], wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

The method of any one of paragraphs [0081] to [0085], wherein the one or more modifiers comprise modifiers for maximum power reduction.

The method of paragraph [0086], wherein the one or more modifiers for maximum power reduction either replace current metrics for maximum power reduction or modify current metrics for maximum power reduction.

The method of any one of paragraphs [0081] to [0085], wherein the one or more modifiers comprise modifiers for cubic metrics.

The method of paragraph [0087], wherein the one or more modifiers for the cubic metrics either replace current metrics for the cubic metrics or modify current metrics for the cubic metrics.

The method of paragraph [0081], wherein the method is performed on a source base station, and the method further includes: in response to a handover of the user equipment from the source base station to a target base station: sending an indication of the codebook to the target base station; and receiving a response from the target base station, the response comprising one of the indication of the codebook or an indication of another codebook; and forwarding the one of the indication of the codebook or the indication of another codebook to the user equipment.

In another exemplary embodiment, a computer program product is disclosed comprising a computer-readable medium bearing computer program code embodied therein for use with a computer, the computer program code comprising code for performing any operation in one of paragraphs [0081] to [0090]. For instance, an exemplary embodiment comprises a computer program product comprising a computer-readable medium bearing computer program code embodied therein for use with a computer, the computer program code comprising: code for determining a codebook to be used by a user equipment to be applied to information to be transmitted by the user equipment; code for determining one or more modifiers corresponding to the codebook, the one or more modifiers to be used by the user equipment to modify metrics used by the user equipment to determine transmit power used for transmissions by the user equipment; code for transmitting the codebook to the user equipment; and code for transmitting the one or more modifiers corresponding to the codebook to the user equipment.

In another exemplary embodiment, an apparatus includes: means for determining a codebook to be used by a user equipment to be applied to information to be transmitted by the user equipment; means for determining one or more modifiers corresponding to the codebook, the one or more modifiers to be used by the user equipment to modify metrics used by the user equipment to determine transmit power used for transmissions by the user equipment; means for transmitting the codebook to the user equipment; and means for transmitting the one or more modifiers corresponding to the codebook to the user equipment.

The apparatus of paragraph [0092], wherein the one or more modifiers is a single value corresponding to the codebook.

The apparatus of paragraph [0092], wherein the one or more modifiers comprises a plurality of modifiers, each of the modifiers corresponding to one or both of modulation order or rank in the codebook.

The apparatus of paragraph [0092], wherein the apparatus further includes: means for, prior to transmitting the codebook, receiving from the user equipment an indication of an antenna configuration of a plurality of antennas of the user equipment; and means for, prior to transmitting the codebook, using the indication to one or both of select the codebook from a plurality of codebooks or determine the codebook.

The apparatus of paragraph [0095], wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

The apparatus of any one of paragraphs [0092] to [0096], wherein the one or more modifiers comprise modifiers for maximum power reduction.

The apparatus of paragraph [0092], wherein the one or more modifiers for maximum power reduction either replace current metrics for maximum power reduction or modify current metrics for maximum power reduction.

The apparatus of any one of paragraphs [0092] to [0096], wherein the one or more modifiers comprise modifiers for cubic metrics.

The apparatus of paragraph [0099], wherein the one or more modifiers for the cubic metrics either replace current metrics for the cubic metrics or modify current metrics for the cubic metrics.

The apparatus of paragraph [0092], wherein the apparatus is a source base station, and the apparatus further includes, responsive to a handover of the user equipment from the source base station to a target base station: means for sending an indication of the codebook to the target base station; means for receiving a response from the target base station, the response comprising one of the indication of the codebook or an indication of another codebook; and means for forwarding the one of the indication of the codebook or the indication of another codebook to the user equipment.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
one or more processors; and
one or more memories including computer program code,
the one or more memories and the computer program code configured to, with the one or more processors, cause the apparatus to perform at least the following:
receiving a codebook;
receiving one or more modifiers corresponding to the codebook;
determining which portion of the codebook is to be applied to information to be transmitted;
applying the portion of the codebook to the information to determine coded information;
using the one or more modifiers, modifying one or more metrics;
determining transmit power to be used for transmission of the coded information by using a selected one of the one or more modified metrics corresponding to the portion of the codebook; and
transmitting the coded information.

2. The apparatus of claim 1, wherein the one or more modifiers is a single value corresponding to the codebook.

3. The apparatus of claim 1, wherein the codebook comprises at least one of a codebook identifier; a maximum transmission rank; a list of a number of precoding matrices for each transmission rank; a list of codebook indexes; and a plurality of precoding matrices.

4. The apparatus of claim 1, wherein the one or more modifiers comprises a plurality of modifiers, each of the modifiers corresponding to one or both of modulation order or rank in the codebook.

5. The apparatus of claim 1, wherein the one or more memories and the computer program code are further configured to, with the one or more processors, cause the apparatus to perform at least the following:
prior to receiving a codebook, transmitting to a base station an indication of an antenna configuration of a plurality of antennas of the user equipment, the indication to be used by the base station to determine the codebook.

6. The apparatus of claim 5, wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

7. The apparatus of claim 1 wherein the one or more modifiers comprise modifiers for maximum power reduction.

8. The apparatus of claim 7, wherein the one or more modifiers for maximum power reduction either replace current metrics for maximum power reduction or modify the current metrics for maximum power reduction.

9. The apparatus of claim 1, wherein the one or more modifiers comprise modifiers for cubic metrics.

10. The apparatus of claim 9, wherein the one or more modifiers for the cubic metrics either replace current metrics for the cubic metrics or modify the current metrics for the cubic metrics.

11. A method, comprising:
receiving a codebook;
receiving one or more modifiers corresponding to the codebook;
determining which portion of the codebook is to be applied to information to be transmitted;
applying the portion of the codebook to the information to determine coded information;
using the one or more modifiers, modifying one or more metrics;
determining transmit power to be used for transmission of the coded information by using a selected one of the one or more modified metrics corresponding to the portion of the codebook; and
transmitting the coded information.

12. The method of claim 11, wherein the one or more modifiers is a single value corresponding to the codebook.

13. The method of claim 11, wherein the one or more modifiers comprises a plurality of modifiers, each of the modifiers corresponding to one or both of modulation order or rank in the codebook.

14. The method of claim 11, wherein the method further comprises:
prior to receiving a codebook, transmitting to a base station an indication of an antenna configuration of a plurality of antennas of the user equipment, the indication to be used by the base station to determine the codebook.

15. The method of claim 11, wherein the one or more modifiers comprise either modifiers for maximum power reduction or modifiers for cubic metrics.

16. A apparatus, comprising:
one or more processors; and
one or more memories including computer program code,
the one or more memories and the computer program code configured to, with the one or more processors, cause the apparatus to perform at least the following:
determining a codebook to be used by a user equipment to be applied to information to be transmitted by the user equipment;
determining one or more modifiers corresponding to the codebook, the one or more modifiers to be used by the user equipment to modify metrics used by the user equipment to determine transmit power used for transmissions by the user equipment;
transmitting the codebook to the user equipment; and
transmitting the one or more modifiers corresponding to the codebook to the user equipment.

17. The apparatus of claim 16, wherein the one or more modifiers is a single value corresponding to the codebook.

18. The apparatus of claim 16, wherein the one or more modifiers comprises a plurality of modifiers, each of the modifiers corresponding to one or both of modulation order or rank in the codebook.

19. The apparatus of claim 16, wherein the one or more memories and the computer program code are further configured to, with the one or more processors, cause the apparatus to perform at least the following:
prior to transmitting the codebook:
receiving from the user equipment an indication of an antenna configuration of a plurality of antennas of the user equipment; and
using the indication to one or both of select the codebook from a plurality of codebooks or determine the codebook.

20. The apparatus of claim 19, wherein the indication of the antenna configuration comprises one or more of the following: an indication the antenna configuration comprises a uniform linear array; an indication of polarization type for the antenna configuration; an indication the antenna configuration comprises a uniform linear array of cross-polarized antenna pairs; or an indication the antenna configuration is undefined as compared to predetermined antenna configurations.

21.-25. (canceled)
